(19) United States
(12) Patent Application Publication
(10) Pub. No.: US 2013/0064490 A1
(43) Pub. Date: Mar. 14, 2013

(54) THERMAL SPRAY COATING OF SLIDING BEARING LINING LAYER

(71) Applicants: Ronald G. Brock, II, Oxford, MI (US); Daniel M. Lonowski, Novi, MI (US); David Domanchuk, Grand Haven, MI (US); Thomas Stong, Kent City, MI (US)

(72) Inventors: Ronald G. Brock, II, Oxford, MI (US); Daniel M. Lonowski, Novi, MI (US); David Domanchuk, Grand Haven, MI (US); Thomas Stong, Kent City, MI (US)

(21) Appl. No.: 13/608,560

(22) Filed: Sep. 10, 2012

Related U.S. Application Data
(60) Provisional application No. 61/534,063, filed on Sep. 13, 2011.

(51) Int. Cl. F16C 33/00; B05D 1/08; C25D 5/02

(52) U.S. Cl. 384/625; 205/122; 427/446

(57) ABSTRACT

A sliding bearing surface may have at least one thermal spray coating applied to the bearing surface to form a sliding bearing lining layer. A method of forming the sliding bearing lining, the method comprising applying the thermal spray coating to the bearing surface uses a thermal spray technique.

### CROSS REFERENCE TO RELATED APPLICATIONS

This application claims priority to U.S. provisional patent application 61/534,063, filed on Sep. 13, 2011, the contents of which are hereby incorporated by reference in their entirety.

### FIELD

The present disclosure generally relates to a thermal spray coating for a bearing.

### BACKGROUND

Traditional internal combustion engines rely on a connecting rod for transmitting combustion power from a piston to the crankshaft of the engine. Connecting rods are typically defined by a first end and a second end. The first end and the second end typically include an aperture disposed therein. Typically, the aperture disposed in the first end of the connecting rod is smaller than the aperture disposed in the second end of the connecting rod. Thus, the aperture in the first end of the connecting rod is configured to connect to the piston by way of a piston pin and the aperture in the second end of the connecting rod is configured to connect to the crankshaft by way of a crankshaft pin.

The connection between the second end of the connecting rod and the crankshaft pin translates the relative motion of the crankshaft to the connecting rod. Typically, a metallic bearing is positioned around the crankshaft pin and/or within an aperture contact surface disposed within the second end of the connecting rod. The bearing generally includes a cast or powdered metal sintered bearing lining layer. This layer provides a sliding bearing surface between the connecting rod and the crankshaft. However, use of a cast or powdered metal sintered bearing lining limits the types of materials that may be used to form the lining. Cast or powdered metal sintered bearing linings are also geared for high volume production. Therefore, a need exists for a bearing lining layer that may be formed from various types of alloys as well as an application process that may allow for greater dimensional flexibility and smaller lot size productions.

### BRIEF DESCRIPTION OF THE DRAWINGS

FIG. 1 illustrates an exemplary piston and connecting rod assembly.

FIG. 2 illustrates an exemplary connecting rod.

FIG. 3 illustrates an exemplary bearing having a thermal spray coating.

FIG. 4 illustrates a method of applying a thermal spray coating to a bearing.

### DETAILED DESCRIPTION

Referring now to the discussion that follows and also to the drawings, illustrative approaches are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description. Indeed, the thermal spray sliding bearing lining layer described herein may be applied to a connecting rod bearing, as described in further detail below, or to any other types of sliding bearings and bushings including, but not limited to, cam shafts, thrust washers, and other rotating shafts.

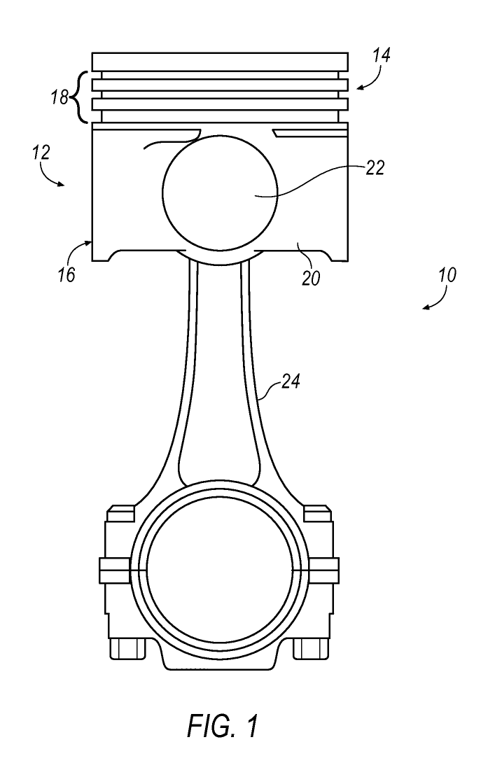

FIG. 1 schematically illustrates a piston and connecting rod assembly 10. The piston and connecting rod assembly 10 includes a piston 12 having a piston crown 14 and a piston skirt 16. The piston crown 14 may include a combustion bowl (not shown) and a ring belt portion 18 configured to seal against an engine bore. The piston skirt 16 is generally configured to support the piston crown 14 during engine operation by interfacing with surfaces of the engine bore to stabilize the piston 12 during reciprocal motion within the bore. The skirt 16 may include pin bosses 20 having apertures 22 configured to receive a piston pin (not shown).

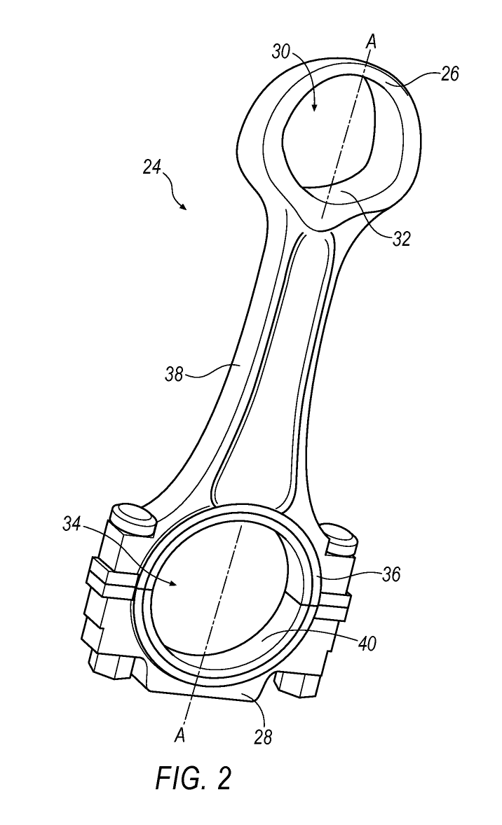

FIG. 2 illustrates an exemplary connecting rod 24. The connecting rod 24 includes a piston pin end or small end 26 and a crankshaft end or large end 28. The piston pin end 26 includes a piston pin bore 30 that defines a piston pin bore surface 32. The crankshaft end 28 includes a crankshaft pin bore 34 that defines a crankshaft bore surface 36. The connecting rod 24 is further defined by a beam 38 extending between the piston pin end 26 and the crankshaft end 28. The beam 38 may include a generally I-shaped cross-section typical of connecting rods or any suitable cross-section, including other quadrangular cross-sections. Thus, the ends 26 and 28 of the connecting rod 24 cooperate to define a longitudinal axis A-A of the connecting rod 24.

Referring back to FIG. 1, the connecting rod 24 may be rotationally coupled to the piston 12 to form the illustrated piston and connecting rod assembly 10. In one exemplary approach, the connecting rod 24 may be coupled to the piston 12 by way of a piston pin (not shown). For example, the piston pin may be inserted through the piston pin bosses 20 and received in the piston pin end 26 of the connecting rod 24 thereby generally securing the connecting rod 24 to the piston 12. While an exemplary piston and connecting rod assembly 10 is shown in FIG. 1, the exemplary components illustrated in the figures are not intended to be limiting. Indeed, additional or alternative components and/or implementations may be used.

In a typical internal combustion engine, the connecting rods transmit combustion power from the piston to the crankshaft of the engine, thereby converting the linear motion of the piston to rotational motion at the crankshaft. Combustion power is generated from the intermittent ignition of combustible fuel such as gasoline that is injected into the combustion chamber, which creates extreme pressures that are applied to the piston and the connecting rod. Thus, the interface between the piston pin bore 30 of the connecting rod 24 and the piston pin experiences continuous radial loads during operation and the interface between the crankshaft bore 34 of the connecting rod 24 and the crankshaft pin experiences continuous rotational motion during operation.

As a result of the forces applied to the piston and connecting rod assembly 10, the piston pin bore 30 and the crankshaft bore 34 may include a bearing 40 disposed therein. Generally engine bearings are comprised of a layered structure, the layers having material properties that may be configured to, for example, increase fatigue strength and improve the seizure and wear resistance of the connecting rod assembly 10. Traditionally, continuous casting and powdered metal sintering processes have been used to produce bearings with various lining layers. However, continuous casting and powdered metal sintering processes are geared for high volume production. Moreover, the types of materials that can be applied to a bearing using continuous casting and powdered metal sintering processes are limited. As just one example, ceramic materials cannot be applied using traditional methods of continuous casting and/or powdered metal sintering. A notable disadvantage considering the material properties of ceramic materials, which allow ceramics to maintain strength even in high temperature environments, such as combustion engines. However, ceramic materials can be made into a powdered form and applied using a thermal spray process.

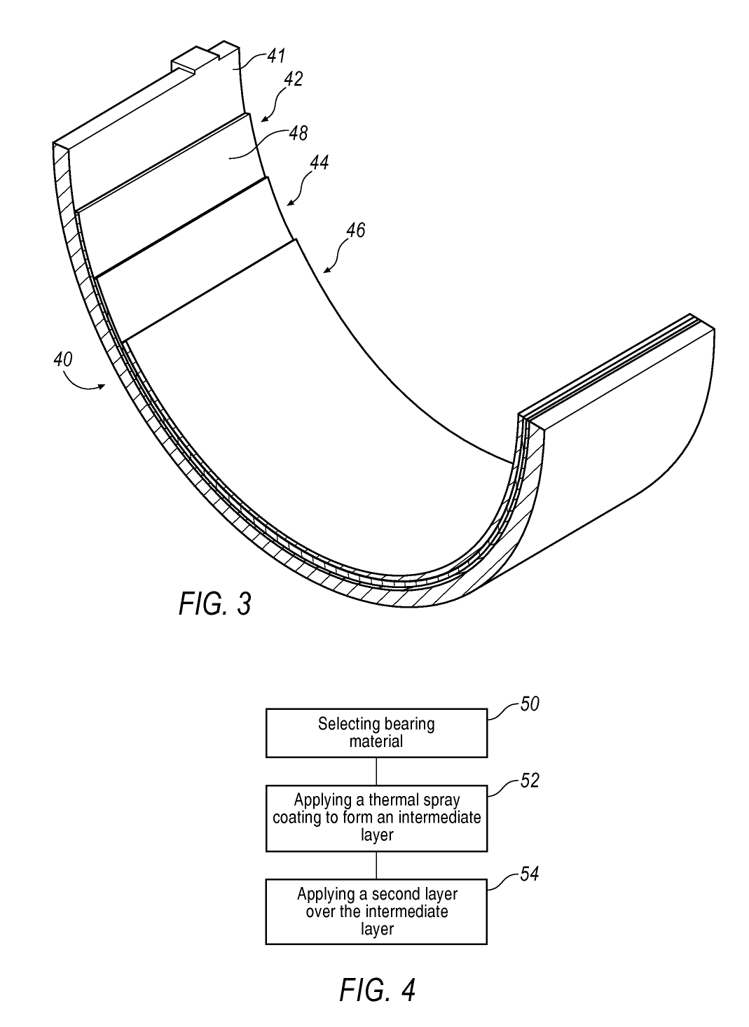

FIG. 3 illustrates a sectioned view of bearing 40 having a thermal spray coating 48 applied thereto. In contrast to the continuous casting and powdered metal sintering processes, the thermal spray process allows for the production of smaller lot sizes and the use of a broader range of materials to form the layered structure. In addition, the thermal spray process may also reduce the volume of scrap, lower the total investment in forming the bearings, and reduce the length of the manufacturing process itself. Moreover, the thermal spray process provides greater flexibility when applying lining layers to half shells or tubes, as discussed in more detail below.

As illustrated in FIG. 3, bearing 40 includes a backing 41 and a three layered structure. The base 41 is typically a metallic material capable of withstanding the environment of a combustion engine including, but not limited to, steel, cast iron, titanium, copper, and respective alloys. The material composing the backing 41 may be in the form of a coiled or precut flat stock, a continuous flat strip, half shells, and/or tubes. In FIG. 3, a lining layer 42 is in contact with backing 41, a barrier layer 44 is applied to lining layer 42, and an overlay 46 is applied over barrier layer 44 such that the barrier layer 44 is disposed between the lining layer 42 and the overlay 46. This type of bearing, sometimes referred to as a trimetallic bearing, is typically used in engines that experience heavy loads.

The lining layer 42 is formed by applying a thermal spray coating 48 directly to the backing 41. The thermal spray coating 48 may be formed of various alloys or any other suitable materials, discussed in more detail below. The lining layer 42 may be selected from a material capable of increasing the durability of the bearing 40. For example, the thermal spray coating 48 may be selected from a material designed to increase the fatigue strength of the bearing 40, provide anti-friction properties, or provide wear resistance and/or seizure resistance properties. The thermal spray coating 48 may also be selected from a material designed to increase the compatibility of the bearing 40. For example, the thermal spray coating 48 may be a copper, tin and bismuth alloy configured to provide not only strength to the bearing 40, but also compatibility. Compatibility of the thermal spray coating 48 allows the bearing 40 to adapt to the use of an irregularly shaped shaft or other misalignments.

Indeed, the thermal spray coating 48 may be comprised of any suitable type of alloy, multiphase alloys, and/or combinations thereof. Examples of such materials include, but are not limited to, copper alloys, aluminum alloys, whitemetals, lead, bismuth, tin, zinc, phosphorus, manganese, tungsten, molybdenum, iron, nickel, cobalt, chromium, titanium, silver, ceramic based materials, silicon, and polymers. The thermal spray coating 48 may be applied such that the lining layer 42 has a suitable thickness based on the engine type and/or the piston type. In one exemplary approach, the lining layer 42 may have a thickness in the range of about 100-1000 microns.

Moreover, the thermal spray coating 48 may be applied using the following thermal spray application methods: high-velocity oxy-fuel technique (HVOF), plasma, arc spray, and/or flame spray. The material(s) selected to form the desired thermal spray coating 48 may be introduced into the spray device such that the material(s) melt or partially melt. Thus, when the material(s) contacts the bearing 40, the thermal spray coating 48 forms a lining layer 42. Additional layers may also be added to the bearing using this method.

The use of spray technique to apply the thermal spray coating 48 may require the use of a heat treatment. The heat treatment normalizes and strengthens the lining layer 42 formed from the thermal spray coating 48 such that residual stresses within the lining layer 42 are removed. The heat treatment may also prevent the lining layer 42 from pulling away from the base 41 after the thermal spray coating 48 has cooled. Machining may also be performed after application of the thermal spray coating 48. Typically, the thermal spray coating 48 forms a rough layer on the bearing 40. Thus, as a result of the tight dimension tolerances of the bearing 40, the thermal spray coating 48 may need to be machined to form a substantially smooth surface. Any suitable machining techniques may be used.

. Heat treatment may further reduce oxides when undertaken in an atmosphere of hydrogen along with an inert gas such as nitrogen. In one exemplary approach, hydrogen comprises between approximately one (1) to ten (10) percent of the total atmosphere with nitrogen comprising essentially the rest of the atmosphere. In one more specific exemplary approach the hydrogen comprises approximately three percent of the atmosphere with nitrogen comprising essentially the rest of the atmosphere for heat treatment. In practice it has been found that when heat treatment takes place in such an atmosphere not only is oxide formation reduced, but the oxides may actually be transformed into a metallic state thereby strengthening the overall coating. Thus, not only is oxide formation reduced or even minimized, it may even be substantially reversed.

Bearing 40 may also include the barrier layer 44. Barrier layer 44 may be applied over the lining layer 42. In one exemplary approach, the barrier layer 44 may be applied as a thermal spray coating. That is, using any suitable thermal spray techniques, a second thermal spray coating may be applied over the thermal spray coating 48 to form the barrier layer 44. The barrier layer 44 may also be applied using any other suitable process. For example, the barrier layer may be electroplated on the lining layer 42 or a physical vapor deposition (PVD) method of depositing the layer, commonly referred to as sputtering, may be used. Like the lining layer, the barrier layer 44 may be applied such that it has a suitable thickness based on the engine type. In one exemplary approach, the barrier layer 44 may have a thickness in the range of about 5.0 microns or less. If the barrier layer 44 is formed by way of a second thermal spray coating, the barrier layer 44 may be machined.

Barrier layer 44 may be formed of various alloys, including those listed above with respect to the lining layer 42, or any other suitable materials. Typically, barrier layer 44 is comprised of a material that is inert or non-reactive with respect to the materials forming the lining layer 44. However, the material forming the barrier layer remains capable of bonding with the lining layer 42. Accordingly, a limited chemical reaction between barrier layer 44 and lining layer 42 is necessary. Thus, in one exemplary approach, a nickel diffusion barrier, sometimes referred to as a nickel dam, may be used.

Barrier layer 44 is configured to prevent the materials comprising the overlay 46 from propagating or depositing into the lining layer 42. Unwanted migration of such materials can have adverse affects on bearing 40. For example, the lining layer 42 may be formed from a thermal spray coating 48 comprising a mixture of copper, lead and tin and the overlay 46 may be comprised of a primarily lead based mixture having some tin and copper. Without the barrier layer, the tin in the overlay 46 is free to migrate into the lining layer 42, decreasing the tin content in the overlay 46. Decreasing the tin content may reduce the corrosion resistance of the overlay 46 as well as the strength of the overlay 46 which makes the bearing 40 more susceptible to seizure and wear. Thus the barrier layer 44 is configured to maintain the material properties of the overlay 46 and the material properties of the lining layer 42.

Bearing 40 may also include the overlay 46. Overlay 46 is applied over the barrier layer 44. In one exemplary approach, the overlay may be applied as a thermal spray coating. That is, using any suitable spray technique, a thermal spray coating may be applied over the barrier layer 44. The overlay 46 may also be electroplated on the barrier layer 44 or a physical vapor deposition (PVD) method may be used. Like the barrier layer 44, the overlay 46 may be applied such that it has a suitable thickness based on the engine type. In one exemplary approach, the overlay 46 may have a thickness in the range of about 1.0 to 30 microns. If the overlay 46 is formed by way of a thermal spray coating, the overlay 46 may be machined.

The overlay 46 may be formed of various alloys, including those listed above with respect to the lining layer 42, or any other suitable materials. Generally, the overlay 46 is comprised of materials that resist seizure between the bearing 40 and a shaft, materials that reduce wear, or improve embedability within the bearing 40 during operation. Like the lining layer 42, the overlay 46 may also be selected from a material designed to increase the compatibility of the bearing 40. For example, the overlay 46 may be a mixture comprised primarily of aluminum with tin. The tin provides a softness or malleability to the overlay 46 such that the bearing 40 is capable of being adjusted to an irregularly shaped shaft or other misalignments. However, the presence of aluminum provides some hardness to the overlay 46 such that the overlay 46 does not wear away during use of the bearing. Thus, the overlay 46 may comprise a mixture of different elements and materials configured to balance the desired properties of the layer.

The selection of the layered structure and the materials used to form the layered structure may be determined based on the load that an engine is likely to experience and the function of the layers. In addition to increasing fatigue strength, seizure resistance, and wear resistance, the layered structure may also be configured to resist corrosion and cavitation. Although bearing 40 having a base 41 and a three material structure has been discussed in detail, the bearing 40 may include less than three layers or more than three layers. In one exemplary approach, the bearing 40 may include a bonding layer. The bonding layer may be used to assist in the application of the thermal spray coating 48 to the base 41 to form the lining layer 42. Use of the bonding layer may eliminate the need for heat treating the thermal spray coating 48 after application.

In another exemplary approach, the bearing 40 may include a two layered structure. Two layered bearings are commonly used in engines that experience medium to high loads, such as diesel passenger vehicles. A two layered bearing may include lining layer 42 and overlay 46. For example, the lining layer 42 may be formed from a thermal spray coating 48 comprising a copper, tin and bismuth mixture and the overlay 46 may be comprised of an aluminum, tin and copper mixture. In this exemplary approach, the overlay 46 may be applied directly to the lining layer 42 using a thermal spray process, it may be electroplated, or it may be applied using a PVD method. In such an approach, the barrier layer 44 is not required because little propagation of elements would occur between the two layers based on the mixtures. Accordingly, the barrier layer 44 may be eliminated.

With reference to FIG. 4, an exemplary method of applying bearing lining layers on base 41 of bearing 40 is illustrated. In Step 50, the backing material is selected. As discussed above, the material for forming backing 40 may be any material suitable to withstand the environment of a combustion engine including, but not limited to, steel, cast iron, titanium, copper, and respective alloys. The backing material may be in the form of a coiled or precut flat stock, a continuous flat strip, half shells, and/or tubes. As discussed above, the following method provides greater flexibility when applying the thermal spray coating 48 to the backing material, especially when utilizing half shells and tubes. With respect to the half shells, the half shells may be preformed or the half shells may be manufactured by stamping, roll forming, and/or machining flat stock or tubes.

The backing 41 may be prepared for application of the thermal spray coating 48. That is the flat stock, the continuous flat strip, the half shells, and/or tubes forming the backing 41 may be cleaned and degreased prior to application. In some exemplary approaches, an exposed surface of the flat stock, the continuous flat strip, the preformed half shells, and/or the tubes, may be roughened to allow for better placement and/or securement of the thermal spray coating 48. Any one of a laser etching process, a water jet blasting process, a grit blasting process, a chemical etching process, or any other suitable mechanical means may be used. The flat stock, the continuous flat strip, the half shells, and/or the tubes may then be cleaned and degreased again prior to application of the thermal spray coating 48.

In Step 52, the thermal spray coating 48 may be applied to the backing 41 using a high-velocity oxy-fuel technique, a plasma spray technique, arc spray or a flame spray coating technique. A heat treatment operation may also be performed to normalize and strengthen the lining layer 42 formed from the thermal spray coating 48 such that residual stresses within the lining layer 42 are removed. Heat treatment may further reduce oxides when in a hydrogen/inert gas based atmosphere as discussed above. The heat treatment may also prevent the lining layer 42 from pulling away from the backing 41 after the thermal spray coating 48 has cooled. A pre-heat treatment may also be provided prior to the application of the thermal spray coating 48. In one exemplary approach, preheating may be performed to eliminate moisture on the surface of the flat stock, the continuous flat strip, the half shells, and/or the tubes prior to application of the thermal spray coating 48 in order to prevent cavitation. It may also be performed to reduce the temperature difference between the backing 41 and the thermal spray coating 48 to prevent separation between the backing 41 and the lining layer 42.

After the thermal spray coating 48 has been applied, the lining layer 42 may be machined to remove any rough surfaces formed by the coating. Indeed, any suitable bearing machining process may be used to form the lining layer 42 into substantially smooth surface, such that the bearing 40 remains within tolerance. Thereafter, as illustrated in Step 54, an additional layer may be applied over the lining layer 42.

Depending on the type of bearing 40 desired, the barrier layer 44 may be applied over the lining layer 42 by using a thermal spray process, by electroplating, or by a PVD method. If the barrier layer 44 is formed using a thermal spray coating, the barrier layer 44 may also require machining depending on the tolerances of the piston and connecting rod assembly. The bearing 40 may also include the overlay 46. As discussed above the overlay 46 may be applied directly over the lining layer 42 or the overlay 46 may be separated from the lining layer 42 by barrier layer 44. Like the barrier layer 44, the overlay 46 may then be applied by using a thermal spray process, by electroplating, or by a PVD method. If the overlay 46 is formed from a thermal spray coating, the overlay 46 may require machining

After the lining layer 42, overlay 46, and/or barrier layer 44 has been applied, the bearing 40 may be disposed within the connecting rod 24. However, with respect to the half shells formed from tubes, the tubes may need to be separated into two equal lengths in order to form the bearing 40 before installation. The separated sections may be formed or stretched to produce a crush height or an over stand dimension for the bearing half shells. The formed half shells may then be machined using any suitable bearing machining process, if necessary. The bearing 40 may then be disposed in the connecting rod using any suitable means. Thus, the bearing 40 described above may be configured for insertion into the piston pin bore 30 and/or the crankshaft pin bore 34.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be possible upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

1. A sliding bearing surface comprising:
a backing;
a thermal spray coating applied to the base layer; and
a layer of material applied over the thermal spray coating.

2. The sliding bearing surface of claim 1, further comprising oxide resistance.

3. The sliding bearing surface of claim 1, wherein the thermal spray forms a lining layer on the base layer.

4. The sliding bearing surface of claim 3, wherein the lining layer has a thickness in a range of about 100-1000 microns.

5. The sliding bearing surface of claim 1, wherein one of a flat stock, a continuous flat strip material, a preformed half shell and a tube is configured to form the bearing.

6. The sliding bearing surface of claim 5, wherein the flat stock, the continuous flat strip material, the preformed half shell and the tube are one of steel, cast iron, aluminum, and copper.

7. The sliding bearing surface of claim 1, wherein the layer of material applied over the thermal spray coating is a barrier layer.

8. The sliding bearing surface of claim 7, wherein the barrier layer is applied by one of a thermal spraying process, an electroplating process, and a physical vapor deposition process.

9. The sliding bearing surface of claim 1, wherein the layer of material applied over the thermal spray coating is an overlay material.

10. The sliding bearing surface of claim 9, wherein the overlay material is applied by one of a thermal spraying process, an electroplating process, and a physical vapor deposition process.

11. The sliding bearing surface of claim 1, wherein a barrier layer is disposed between the thermal spray coating and an overlay material.

12. The sliding bearing surface of claim 1, wherein in one of a high-velocity oxy-fuel technique, a plasma spray technique, arc spray and a flame spray coating technique is used to apply the thermal spray coating.

13. The sliding bearing surface of claim 1, wherein the thermal spray coating is one of copper, aluminum, a whitemetal, lead, bismuth, tin, zinc, phosphorus, manganese, tungsten, molybdenum, iron, nickel, cobalt, chromium, titanium, silver, a ceramic based material, silicon, and a polymer.

14. The sliding bearing surface of claim 1, wherein the material comprising the thermal spray coating may be one of an alloy, a multiphase alloy, and any combination thereof.

15. A method of forming a sliding bearing surface comprising:
applying a thermal spray coating to one of a flat stock, a continuous flat strip material, a half shell, and a tube configured to form a bearing,
wherein the thermal spray coating is applied directly to a backing thereby forming a sliding bearing lining layer.

16. The method of claim 15, further comprising applying a second layer of material over the thermal spray coating, wherein the layer of material is applied by one of a thermal spraying process, an electroplating process, a physical vapor deposition process, and a polymer coating process.

17. The method of claim 15, further comprising applying the thermal spray coating using one of a high-velocity oxy-fuel technique, a plasma spray technique, arc spray and a flame spray coating technique.

18. The method of claim 15, further comprising machining the thermal spray coating to form a substantially smooth surface

19. The method of claim 15, further comprising applying a third layer of material over the thermal spray coating, wherein the third layer of material is applied by one of a thermal spraying process, an electroplating process, a physical vapor deposition process, and a polymer coating process.

20. The method of claim 15, further comprising heat treating the thermal spray coating in an atmosphere containing between approximately one to ten percent hydrogen and the rest essentially an inert gas for normalizing and strengthening the lining layer while at least reducing oxide formation.
